(19) United States
(12) Patent Application Publication
(10) Pub. No.: US 2006/0102763 A1
(43) Pub. Date: May 18, 2006

(54) Blade pairs for a paper shredder

(75) Inventor: Shuhui Bai, Jinjiang City (CN)

Correspondence Address: Jike Cui, 6 Colonial Village Drive, #8, Arlington, MA, 02474, US

(73) Assignee: SPLENDID ELECTRONICS (SHENZHEN) COMPANY LIMITED

(21) Appl. No.: 11/246,891

(22) Filed: Oct. 11, 2005

(30) Foreign Application Priority Data
Nov. 17, 2004 (CN) 2004200955527

(51) Int. Cl. B02C 18/16

(52) U.S. Cl. 241/295

(57) ABSTRACT

Blade pairs for a paper shredder comprises two single blades with a flange rib on the surface of each blade, and the flange ribs of two single blades are against each other when shredding the paper. A hole is in the center of each blade. 2-8 corresponding blade points are arranged at the edge of each blade, which slant a certain degree beyond the plane of the blades, and the blade points of each blade pairs meet at a certain angle when assembled. Blade pairs is processed easily and it can save raw material.

### BACKGROUND OF THE INVENTION

1. Field of the Invention

This invention generally relates to a blade, especially refers to blade pairs for paper shredder.

2. Description of the Related Art

People often need to destroy the file paper during their work and in their daily life, in order to prevent the files being disclosed, so shredder has been an important tool to get rid of files. Now there are two kinds of shedders, one is strip-cut shredder, the other is cross-cut shredder, they are either manual or electric. Cross-cut shredder is used to cut the waste paper into paper shreds. Normally a shredder blade includes two single blades which are against each other, the two single blades are fixed on the two parallel rotary shafts. When the shafts rotate, waste paper passes through the two single blades. In general, the thickness of two single blades equals to the width of shred, so the blade is too thick, and processing the blade needs more material.

### SUMMARY OF THE INVENTION

An object of the present invention is to provide blade pairs for a shredder blade, said blade pairs has a simple structure, which is processed easily and can save raw material.

Blade pairs for a shredder blade according to the present invention comprises two single blades, a flange rib extending from a surface of each single blade, said flange ribs are against each other when the two single blades are assembled together, a mounting hole is defined in the middle of each blade, several corresponding blade points are around each blade. The blade points slant in certain degree beyond the plane of the blades, therefore, they meet at a certain angle when assembled. Because of the existence of flange ribs, the thickness of two single blades before assembled is less than that of pair blades when assembled.

Therein blade supports are defined on the blade surface, the blade supports are against the surface of the other blade, and they are set between two blade points at the edge of one blade.

The optimal number of blade points ranges from two to eight, and they are evenly distributed on the periphery of the blade.

The number of blade supports is equal to that of blade points.

The hole in the middle of each blade can be a dodecagon, hexagon or sawtooth.

Compared with the common paper shredder blade, the invention has the following features:

Each blade has a flange rib, the two flange ribs are against each other when assembled, the thickness of the pair blades when assembled is less than the width of the cutting size, therefore processing the blade can save raw material. What's more, there are a few supports between the blades, which can prevent the paper shreds flowing into the gap of the two blades. Furthermore, the precision of processing mold is not very high.

Other objects, advantages and novel features of the present invention will be drawn from the following detailed description of a preferred embodiment of the present invention, with attached drawings, in which:

### BRIEF DESCRIPTION OF THE DRAWINGS

FIG. 1 is an exploded, perspective view of blade pairs;

FIG. 2 is a side view of one blade of the invention;

FIG. 3 is a side view of the other blade of the invention;

FIG. 4 is an assembled, perspective view of the present invention coupled to a shaft.

### DETAILED DESCRIPTION OF THE PREFERRD EMBODIMENT

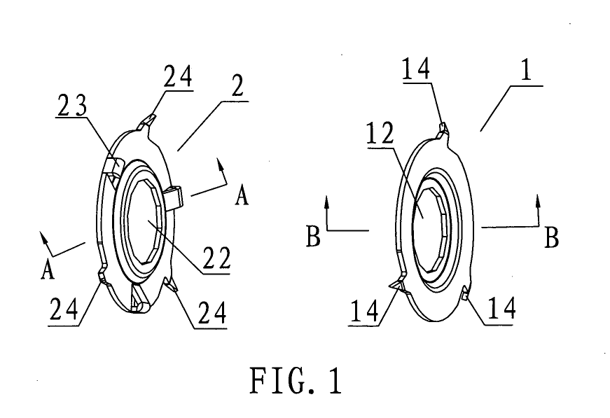

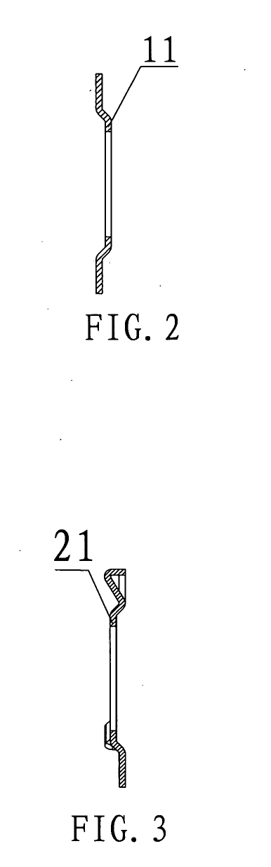

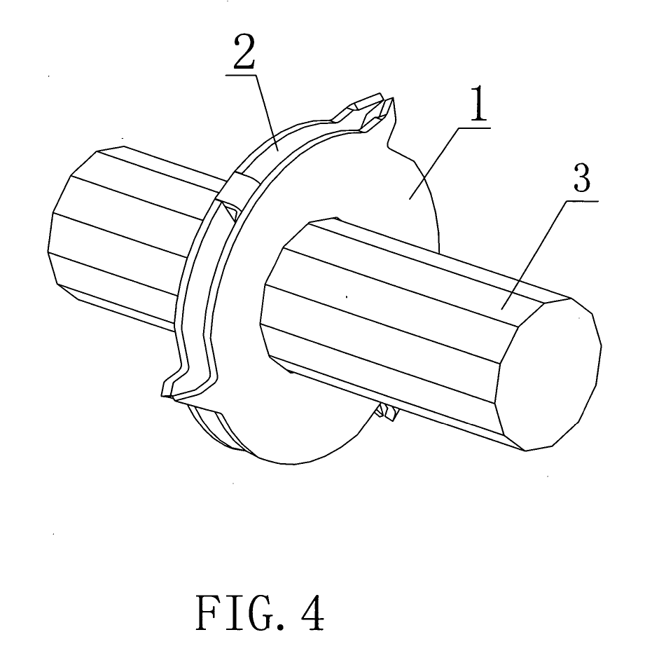

According to FIGS. 1, 2 and 3, blade pairs used for a paper shredder according to the present invention comprises two single blades 1 and 2.

There are two flange ribs 11 and 21 extending up from the surface of two blades, and the two flange ribs 11 and 21 are against each other when assembled together. The thickness of each blade is 0.8 mm, however the thickness of the pair blades when assembled is 4 mm because of the extra thickness of two flange ribs 11 and 21. There are two mounting holes 12 and 22 respectively defined in the middle of corresponding blade pairs 1 and 2, the two mounting holes 12 and 22 are dodecagon. Three pairs of corresponding blade points 14 and 24 extend from the surface of the blade pairs 1 and 2. They are arranged evenly around the mounting hole 11 and 21. The blade points 14 and 24 slant a certain degree beyond the plane of the blade pairs 1 and 2, therefore, they are against each other when the blade pairs 1 and 2 are assembled. There are three blade supports 23 on the blade 2.

According to FIG. 4, the two single blades 1 and 2 are fixed onto the rotating shaft through the mounting holes 12 and 22, the shape of cross-section of the rotating shaft is also dodecagon, therefore, it goes well with the mounting holes 12 and 22.

1. Blade pairs for a paper shredder comprising:
two single blades;
wherein a flange rib is extended respectively from the surface of the single blades, a mounting hole is defined in the middle of each blade, at least two blade points are arranged around the single blades.

2. The blade pairs as claimed in claim 1, wherein the number of blade points of each single blade is the same.

3. The blade pairs as claimed in claim 1, wherein the blade points slant a certain degree beyond the plane of the blades, which meet at a certain angle when assembled.

4. The blade pairs as claimed in claim 1, wherein on the periphery of one blade there are blade supports located between two blade points of the blade, and the blade supports of one blade are attached to the surface of the other blade.

5. The blade pairs as claimed in claim 1, wherein there are at least two pairs of corresponding blade points.

6. The blade pairs as claimed in claim 5, wherein three pairs of corresponding blade points are arranged on the periphery of each blade.

7. The blade pairs as claimed in claim 6, wherein three blade supports are on the blade.

8. The blade pairs as claimed in claim 1, wherein the shape of mounting hole is dodecagon.
